(19) United States
(12) Patent Application Publication
(10) Pub. No.: US 2008/0251356 A1
(43) Pub. Date: Oct. 16, 2008

(54) System for particulate removal and reclamation in a manufacturing environment

(76) Inventors: Peter Bratusa, Guelph (CA); Jonathan R. Burke, Stratford (CA)

Correspondence Address: Jeffrey Thurnau;The Gates Corporation;, IP Law Dept. 10-A3, 1551 Wewatta Street, Denver, CO, 80202, US

(21) Appl. No.: 12/077,243

(22) Filed: Mar. 18, 2008

Related U.S. Application Data
(60) Provisional application No. 60/911,648, filed on Apr. 13, 2007.

(51) Int. Cl. B65G 45/22

(52) U.S. Cl. 198/495

(57) ABSTRACT

A pneumatic recirculating system for particulate material removal and reclamation in a manufacturing environment comprising, a conveyor, a housing cooperatively disposed with the conveyor, an air pump pneumatically connected to a manifold for extracting air from the housing, an air knife cooperatively disposed with respect to the manifold, the air knife directing an air flow toward a product on the conveyor, a separator pneumatically connected to the air pump discharge for removing particulate material removed from the housing; and a separator discharge pneumatically connected to the air knife.

### REFERENCE TO RELATED APPLICATIONS

This application claims priority from U.S. provisional application Ser. No. 60/911,648 filed Apr. 13, 2007

### TECHNICAL FIELD

The present invention relates to a pneumatic recirculating system for removing and reclaiming particulate from a product in a manufacturing environment.

### DESCRIPTION OF THE PRIOR ART

Particulate generation is widespread among several sectors of the manufacturing industry. For example, it is common in a sintering operation for powdered particulate to be present on the surfaces of moulded pieces prior to heating. Similarly, surplus flour is readily applied to manufactured baked goods to discourage friction with manufacturing surfaces. Wood particulate is generated in a variety of activities in a woodworking operation. Extraneous particulate material can adversely affect the subsequent operations and may also be a health and safety concern in some environments.

In particular, presence of particulate on the surface of manufactured goods is undesirable for subsequent operations in the manufacturing process. Sintering of a piece covered in powdered metal particulate would result in rough, uneven surfaces. Presence of excess flour during baking and packaging increases the probability of unwanted flour in the finished product. Lacquering or painting wood surfaces covered in wood particulate would produce an unsightly finish, contrary to the ideal specifications of the overall process. Removal of particulate from surfaces is advantageous to facilitate wholly effective manufacturing processes. The typical method of particulate removal is a constant stream of compressed air by which dusts are blown off the material surfaces into the surrounding environment.

This practice of particulate removal is both hazardous and costly. In the short term, particulate presence in a manufacturing environment is an irritant to many, thereby negatively influencing safe work practices. Moreover, the effects of prolonged exposure to many particulates are unknown. In addition to expense required to maintain a constant stream of compressed air, the dispersal of excess particulate is wasteful of a raw material used in the process. Reclamation of such raw materials would naturally reduce manufacturing costs.

Representative of the prior art is U.S. Pat. No. 5,566,813 (1996) to Thomas et al which discloses a method and apparatus for cleaning dust and particulate from automated mail processing equipment having a conveyer disposed along a plurality of processing stations is provided. The cleaning system includes at least one air nozzle disposed at each station and at least one vacuum port disposed at each station and spaced apart from the air nozzle. A vacuum for creating a vacuum at the vacuum port and an air source for directing air through the air nozzle is provided. A sequencer for allowing air to sequentially pass through the air nozzle at each station while a vacuum is created at the same station is provided. A controller in communication with the sequencer is provided for relaying sequencing information to the sequencer.

What is needed is a pneumatic recirculating system for removing and reclaiming particulate from a product in a manufacturing environment. The present invention meets this need.

### SUMMARY OF THE INVENTION

The primary aspect of the invention is to provide a pneumatic recirculating system for removing and reclaiming particulate from a product in a manufacturing environment.

Other aspects of the invention will be pointed out or made obvious by the following description of the invention and the accompanying drawings.

The invention comprises a pneumatic recirculating system for particulate material removal and reclamation in a manufacturing environment comprising, a conveyor, a housing cooperatively disposed with the conveyor, an air pump pneumatically connected to a manifold for extracting air from the housing, an air knife cooperatively disposed with respect to the manifold, the air knife directing an air flow toward a product on the conveyor, a separator pneumatically connected to the air pump discharge for removing particulate material removed from the housing; and a separator discharge pneumatically connected to the air knife.

### BRIEF DESCRIPTION OF THE DRAWINGS

Embodiments of the invention will now be described by way of example only with reference to the appended drawings wherein:

FIG. 1 is a perspective view of a particle removal apparatus.

FIG. 2 is a side view in section of the apparatus at FIG. 1.

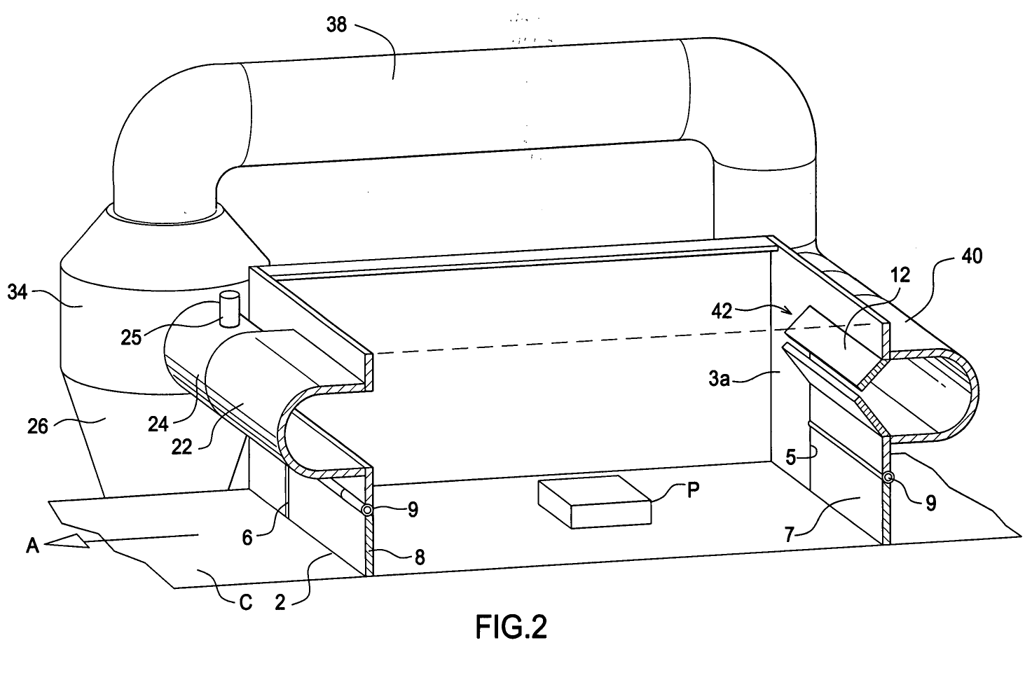

FIG. 3 is a top perspective view of the apparatus of FIG. 1.

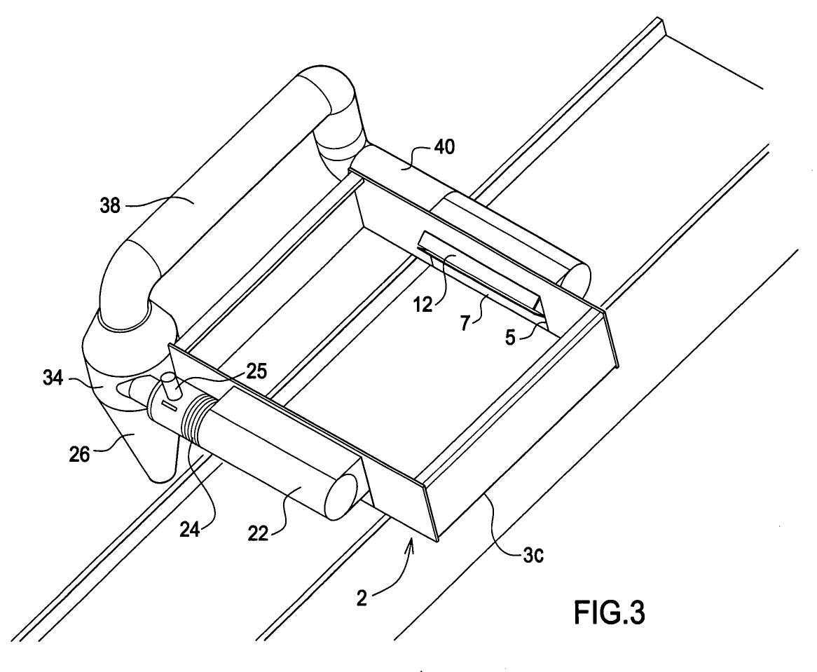

FIG. 4 is a schematic diagram illustrating air flow and particulate flow within the apparatus.

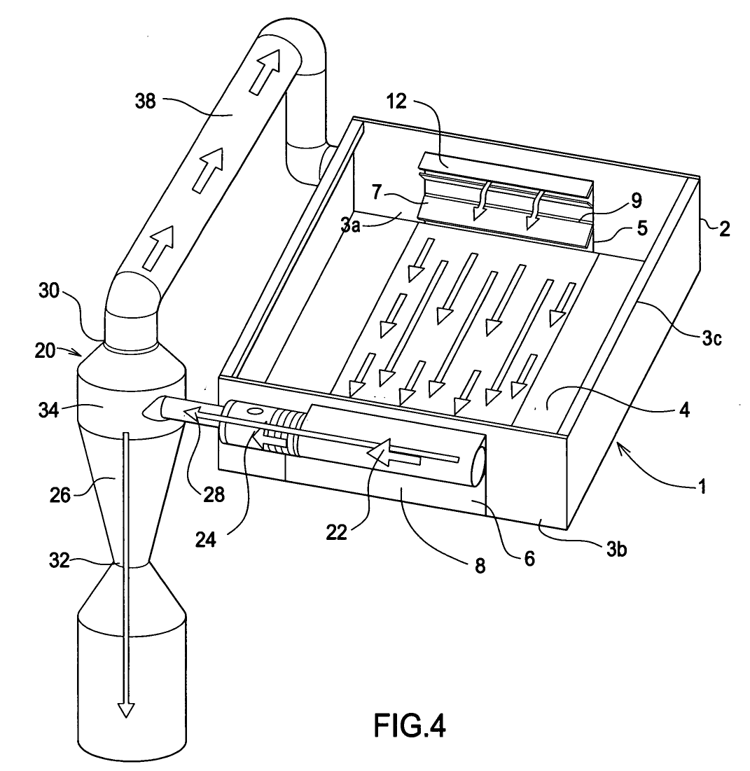

### DETAILED DESCRIPTION OF THE DRAWINGS

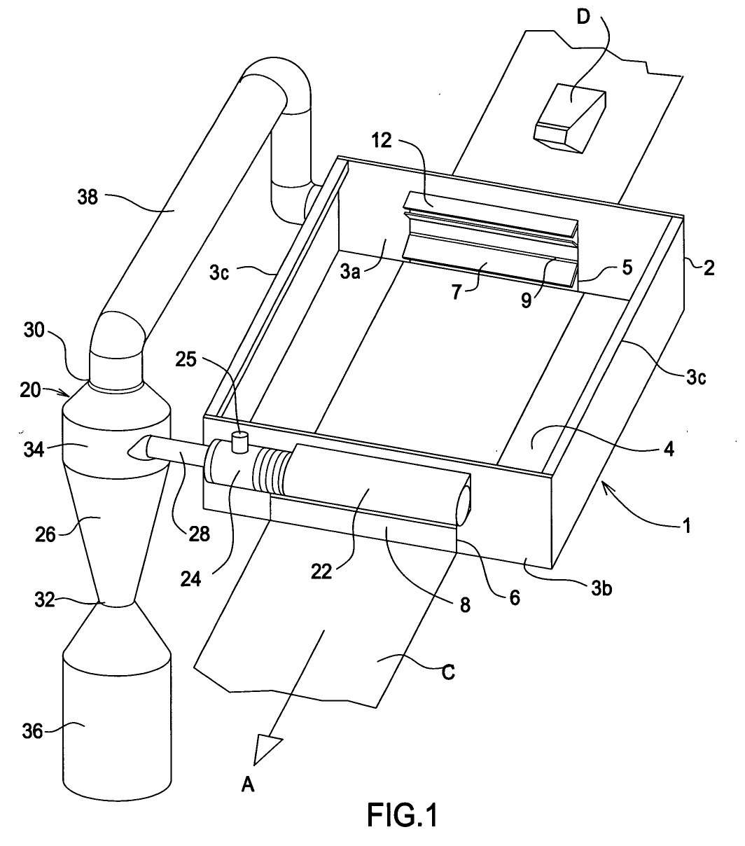

Referring therefore to the drawings and in particular FIG. 1, a product transfer station includes a conveyor C upon which products P are moved in the direction of the arrow A. A particle removal apparatus 1 is located on the conveyor C in the path of the products P to remove extraneous particulate material from the surface of the product.

The particle removal apparatus 1 includes a housing 2 having upstream and downstream end walls 3a, 3b respectively and side walls 3c. A lid 4 is supported on the upper edge of the walls 3 and is sealed to the walls.

Each of the end walls 3a, 3b has an opening 5, 6 respectively. A door 7, 8 is pivotally mounted in the opening for movement about a transverse horizontal axis by hinges 9. The openings 5, 6 extend substantially the entire width of the conveyor C so as not to impede progress of the product P.

Each of the end walls 3a, 3b has an elongated slot 12, 13 positioned above the respective opening. The slot 12 on the upstream wall 3a is lower than the slot 13 on the down stream wall 3b.

An air re-circulation system generally indicated at 20 is connected between the slots 12, 13 to re-circulate air through the housing 2. The air re-circulation system includes a manifold 22 pneumatically connected to the slot 13 on the down stream end wall 3b. The manifold is pneumatically connected to an injector vacuum pump indicated at 24 which is supplied with compressed air from a compressor (not shown) through an inlet 25. A suitable pump is available from Taylor Fluids Limited under Model# CDS/750, although this is not intended to limit the use of various other suitable pumps available in the art.

The output of the pump 24 is connected to a vertically mounted cyclone particulate separator 26 having an air intake 28, air output 30 and particulate output 32. A separation chamber 34 is provided between the intake 28 and the outputs 30, 32 in a conventional manner. A particulate collection device 36 is positioned below the particulate output 32.

A reclaimed air transfer conduit 38 is connected to the air output 30 and extends along the length of the housing 2. The conduit 30 is connected through elbows with an inlet manifold 40 which covers the slot 12 and is hermetically sealed to the end wall 3a.

A stationary air knife 42 shown in ghosted outline may be provided at the slot 12 mounted within to direct air across the surface of the component.

In operation, the housing 2 is positioned on a conveyor system so as not to impede material transfer. The application of compressed air to the air intake induces a re-circulating flow of air from the interior of housing 2, through the separator 26 and air transfer conduit 38 back to the housing 2. As components P with surface particulate are transported through entry door by conveyor C, the air flow from the slot 12 or stationary air knife 46 projects a high velocity stream of compressed air across the surfaces of the component thereby removing surface particulate. The vacuum pump 24 draws air from the housing 2 to circulate contaminated air from the housing 2, through vacuum pump 24 and into the air intake 28 of cyclone particulate separator 26.

Cyclone particulate separator 26 functions based on centrifugal acceleration and pressure differences acting on particulate of varying specific gravity, generated when the high velocity particulate-contaminated air is received tangentially to that of the vertical upper portion of the cyclone. The centrifugal force generated by the high velocity cyclone input pushes particulate against the inner walls of cyclone particulate separator 26. At the same time, gravity continues to exert a downward force on the particulate, resulting in an inverted conical descent along the inside wall of the cyclone. Particulate exits the cyclone particulate separator 26 via the output 36 and into the particulate collection means 36. Concurrently, a narrow cyclone, coaxial to that of the first acts in an upward direction discharging particulate-free air from the cyclone particulate separator 34, through air outlet 38.

The non-contaminated air stream passes through air transfer conduit 38 and manifold 40 for re-circulation within the housing 2.

In this manner, the particulate material is removed from the component within the closed environment of the housing 2 and is recovered in the cyclone 26 for subsequent use.

The use of the injection pump reduces the consumption of compressed air and the recirculation of the air in a closed loop inhibits the distribution of particulate in the air. The recovery of the particulate reduces the use of raw material where is may be recycled.

In the embodiment above, the housing 2 is sealed by the doors 5, 7. In an alternative arrangement, the openings in the housing 2 may be covered with flexible rubber sheet, with a cut out conforming closely to the shape of the article. With this arrangement it has been found that the momentary sealing as the component passes through the opening is sufficient to induce a high velocity flow of air around the article from outside the box 2 and displace particulates. In these circumstances, the air knife is not required.

Although a form of the invention has been described herein, it will be obvious to those skilled in the art that variations may be made in the construction and relation of parts without departing from the spirit and scope of the invention described herein.

I claim:

1. A pneumatic recirculating system for particulate material removal and reclamation in a manufacturing environment comprising:
a conveyor;
a housing cooperatively disposed with the conveyor;
an air pump pneumatically connected to a manifold for extracting air from the housing;
an air knife cooperatively disposed with respect to the manifold, the air knife directing an air flow toward a component on the conveyor;
a separator pneumatically connected to the air pump discharge for removing particulate material removed from the housing; and
a separator discharge pneumatically connected to the air knife.

2. The system as in claim 1, wherein the separator comprises a cyclone separator.

3. The system as in claim 1, wherein the air pump comprises an injector vacuum pump.

4. The system as in claim 1, wherein the housing comprises a door for receiving a component and a door whereby the component exits the housing.

5. The system as in claim 1 further comprising a particulate collection means connected to the separator.
